(19) United States
(12) Patent Application Publication
(10) Pub. No.: US 2018/0060024 A1
(43) Pub. Date: Mar. 1, 2018

(54) INTELLIGENT SWITCH AND INTELLIGENT HOME SYSTEM USING THE SAME

(71) Applicant: Shenzhen Xinguodu Technology Co., Ltd., Shenzhen City (CN)

(72) Inventor: Xianghong LIU, Shenzhen City (CN)

(73) Assignee: Shenzhen Xinguodu Technology Co., Ltd, Shenzhen City (CN)

(21) Appl. No.: 15/364,552

(22) Filed: Nov. 30, 2016

(30) Foreign Application Priority Data
Aug. 26, 2016 (CN) 201610740775.1

(51) Int. Cl. G06F 3/16; G10L 15/22; H04S 7/00; H04R 5/04

(52) U.S. Cl. CPC G06F 3/165; G10L 15/22; G10L 2015/223; H04R 5/04; H04S 7/303

(57) ABSTRACT

Disclosed is an intelligent switch and an intelligent home system using the same. The intelligent switch includes a main control chip, a relay, a Wi-Fi communication module, an AC-DC power module, a sound collection module and an audio playback module. The intelligent home system includes intelligent switches, a cloud server, household appliances and a mobile terminal, to realize functions of sound localization, stereophonic playback, sound channel switching, speech recognition control, etc., through communication among the intelligent switches, cloud server, household appliances and a mobile terminal, and to realize diversified control of the intelligent switches and diversified functions of an intelligent home, for users to lead a more convenient and more comfortable life. The intelligent switch and intelligent home system using the same are widely applied in the technical field of intelligent homes.

### CROSS-REFERENCE TO RELATED APPLICATIONS

This application claims priority to Chinese patent application serial number 201610740775.1, filed on Aug. 26, 2016, which is hereby incorporated herein in its entirety by reference.

### FIELD OF THE INVENTION

The present invention relates to intelligent homes, and in particular to an intelligent switch and an intelligent home system using the same.

### BACKGROUND

The present invention relates to intelligent homes, and in particular to an intelligent switch and an intelligent home system using the same.

In the prior art, houses are platforms for intelligent homes and household appliances are the main controlled objects thereof. Housing facilities are integrated efficiently through comprehensive wiring technology, network communication technology, safety guard technology, automatic control technology and audio-video technology, to build an efficient control management system for housing facilities and a daily schedule of a family, which enhances intelligence, safety, convenience and comfort in houses and realizes a comprehensive and intelligent household network control system platform with environmental protection and energy saving.

Control of switches is critically important in a modern house, however, a large number of electrical system leakage and fires due to a power supply not being cut off are reported. An intelligent switch is generally referred to as a switch having a built-in Wi-Fi unit functionally operated by a mobile client, with the control of timing and power on or off remotely controlled by the mobile client. An existing intelligent switch is disadvantageous in that it only has a single control mode, single function, poor operability and lack of an entertainment mode of operation. Further, an intelligent home system combining practicability, entertainment, safety, convenience and comfort is desired.

### SUMMARY

Aiming at solving the technical problems mentioned above, the present invention provides an intelligent switch with multifunctions, high operability, safety and convenience, and an intelligent home system using the same.

In one aspect of the present invention, there is provided an intelligent switch comprising a relay; an audio playback module; a main control chip, with output terminals of the main control chip connected with input terminals of the relay and input terminals of the audio playback module, respectively; a Wi-Fi communication module, wherein the main control chip is connected with the Wi-Fi communication module; an AC-DC power module, with output terminals of the AC-DC power module connected with input terminals of the main control chip; a sound collection module, with output terminals of the sound collection module connected with input terminals of the main control chip.

The intelligent switch further comprises a storage medium connected with the main control chip.

The intelligent switch further comprises a power measurement module with its output terminals connected with input terminals of the main control chip.

The intelligent switch further comprises a gesture-sensing module with its output terminals connected with input terminals of the main control chip.

The intelligent switch further comprises a control panel connected with the main control chip and comprising a touch screen and/or buttons.

In another aspect, the present invention further provides an intelligent home system comprising at least two intelligent switches as any one described above; a router; a mobile terminal controlling the intelligent switches; a cloud server connected with the intelligent switches and the mobile terminal respectively through the router; and household appliances connected with the intelligent switches, wherein the mobile terminal controls power on and off of household appliances via intelligent switches.

The intelligent switches further comprise sound localization units for identifying locations of a voice source according to collected sound information.

The cloud server further comprises a stereophonic playback unit for the cloud server operable to synchronize all of the intelligent switches and to control the intelligent switches to play stereo.

The cloud server further comprises an automatic switching unit operable to switch sound channels of the cloud server and control an intelligent switch positioned in close proximity to a person to play a main channel audio signal or to enhance sounds according to a detected location of a voice source.

The intelligent switch further comprises a speech recognition unit for recognizing voice commands.

The present invention is advantageous in that the present invention is provided with a main control chip, a relay, a Wi-Fi communication module, an AC-DC power module, a sound collection module and an audio playback module, wherein the relay is controllable by the main control chip, and the switches of the household appliances are controllable by the relay; the AC-DC power module supplies electricity for the entire circuit; communication with a smart terminal is achieved through the Wi-Fi communication module; and the intelligent switch is controllable by the smart terminal. The present invention is further provided with a sound collection module, which is arranged to realize voice control through speech recognition; and an audio playback module performing functions such as music playback and human-machine interaction, for purpose of multifunction, high operability, safety and convenience.

Additionally, the present invention further provides an intelligent home system arranged to perform functions such as sound localization, stereophonic playback, sound channels switching, speech recognition control, etc, so as to realize diversified functions for an intelligent home, through communications among the intelligent switches, cloud server, household appliances and mobile terminals, allowing users to lead a more convenient and more comfortable life.

### DESCRIPTION OF THE DRAWINGS

Specific embodiments of the present invention will be further described in detail hereinafter with reference to the drawings, wherein:

FIG. 1 is a block diagram of an intelligent switch according to the present invention;

FIG. 2 is a block diagram of an audio playback module of the intelligent switch according to the present invention;

FIG. 3 is a block diagram of a sound collection module of the intelligent switch according to the present invention;

FIG. 4 is a block diagram of an intelligent home system according to the present invention.

### DETAILED DESCRIPTION

It should be noted that embodiments of the application and features in the embodiments are exemplary only, and that the embodiments and features can be combined with each other in various manners within the scope of the present invention.

### First Embodiment

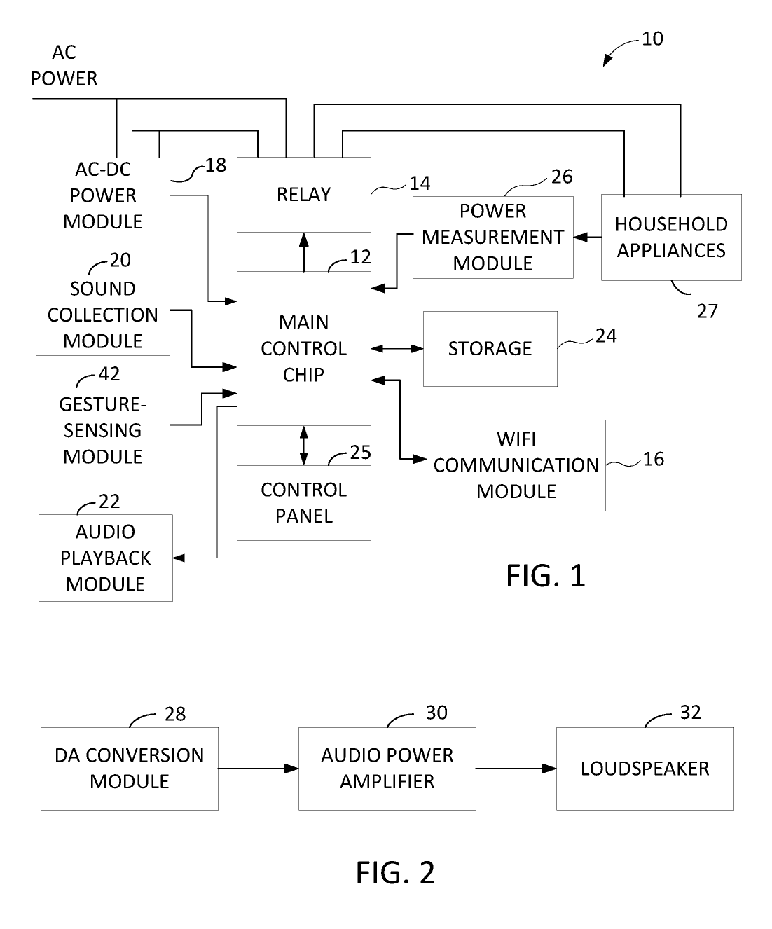

As shown in FIG. 1, an intelligent switch 10 comprises a main control chip 12, a relay 14, a Wi-Fi communication module 16, an AC-DC power module 18, a sound collection module 20 and an audio playback module 22. Output terminals of the main control chip 12 are connected with input terminals of the relay 14 and input terminals of the audio playback module 22, respectively; both output terminals of the sound collection module 22 and output terminals of the AC-DC power module 18 are connected with input terminals of the main control chip 12; and the main control chip 12 is connected with the Wi-Fi communication module 16.

Communication with a smart terminal (not shown) is achieved through the Wi-Fi communication module 16, such that the intelligent switch 10 is controllable by the smart terminal. The present invention is further provided with a sound collection module 20, which is arranged to realize voice control through speech recognition; and an audio playback module operable to perform functions such as music playback and human-machine interaction, for the purpose of multifunction, high operability, safety and convenience

Preferably, as shown in FIG. 1, the intelligent switch further comprises a storage device 24 connected with the main control chip 12, wherein said storage device 24 stores information about power threshold values and voice commands, and optionally stores audio files.

Preferably, as shown in FIG. 1, the intelligent switch further comprises a control panel 25 connected with the main control chip 12, wherein said control panel 25 comprises a touch screen and/or buttons. Said main control chip 12 is connected with the touch screen, such that the intelligent switch can be operated and controlled through the touch screen, while information about the intelligent switch, pre-warning prompts, operation prompts and functional options can be displayed on the screen. Preferably, the main control chip 12 is further connected with the buttons for operating and controlling the intelligent switch.

Preferably, as shown in FIG. 1, the intelligent switch further comprises a power measurement module 26 with output terminals thereof connected with input terminals of the main control chip 12. The power measurement module 26 can measure operating power of a household appliance 27 by connecting with power input terminals of the household appliance 27. The main control chip 12 can compare the operating power of the household appliance 27 with a preset power threshold value stored or saved on the storage device. When the operating power exceeds the preset power threshold value, which means the household appliance 27 may break down, the main control chip 12 will output fault information to the touch screen of the control panel 25 to display a prompted message, and at the same time the relay 14 is activated to cut off AC power supply to the household appliance 27, so as to prompt users and avoid a breakdown and further damage to the household appliance 27.

Preferably, as shown in FIG. 2, said audio playback module 22 further comprises a digital to analog (DA) conversion module 28, an audio power amplifier 30 and a loudspeaker 32. Output terminals of the main control chip 12 are connected with an input terminal of the loudspeaker 32 through the DA conversion module 28 and the audio power amplifier 30, respectively. The intelligent switch can obtain audio data through the Wi-Fi communication module 16 and the smart terminal. Audio data output from the main control chip 12, i.e. digital signals, are converted into analog signals through the DA conversion module 28, and the analog signals are amplified through the audio power amplifier 30 and output into the loudspeaker 32, such that music playback is realized with volume able to be adjusted through the power amplifier.

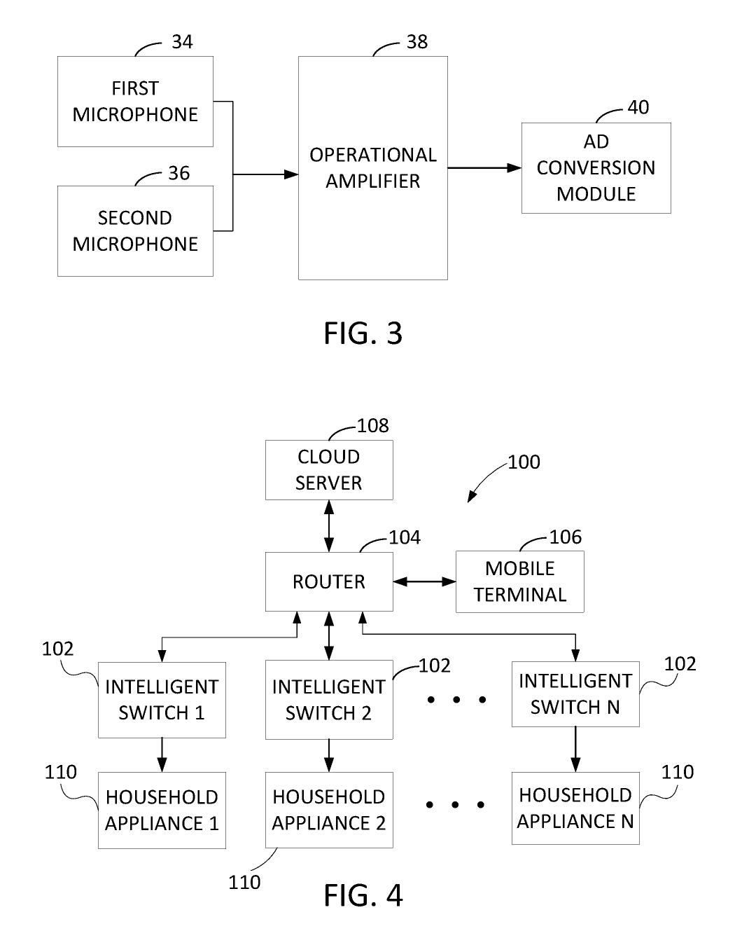

Preferably, as shown in FIG. 3, said sound collection module further comprises a first microphone 34, a second microphone 36, an operational amplifier 38 and an analog to digital (AD) conversion module 40. An output terminal of the first microphone 34 and an output terminal of the second microphone 36 are connected with input terminals of the main control chip 12 through the operational amplifier 38 and the AD conversion module 40. Audio data is collected through the microphones 34, 36 and amplified through the operational amplifier 38, and analog signals are converted into digital signals through the AD conversion module 40, then the digital signals are transmitted to the main control chip 12. The main control chip 12 compares the audio data collected through the microphones 34, 36 with voice commands on the storage device and judges whether the audio data collected through the microphones matches with any preset voice commands on the storage device, if yes, the main control chip 12 executes a corresponding operation.

Looking back to FIG. 1, preferably, the intelligent switch 10 further comprises a gesture-sensing module 42 with output terminals thereof connected with input terminals of the main control chip 12. Said gesture-sensing module 42 comprises infrared light receiving diodes and infrared light transmitting diodes, with output terminals of the infrared light receiving diodes connected with input terminals of the main control chip 12 and input terminals of the infrared light transmitting diodes connected with output terminals of the main control chip 12. Gesture-sensing is realized through infrared light, i.e. sensing and detecting a hand gesture with infrared light, in order to turn off the speaker or turn down the volume with specific gesture commands when playing music (in the case that the voice commands are unable to be collected reliably), allowing voice commands to then be collected clearly.

More preferably, with sound localization technology based on a dual microphone array, the location of a voice source or other sound can be determined. The principle of such technology is that, in the course of the propagation of sound waves, amplitude attenuation occurs and the attenuation factor is proportional to the propagation distance, and there is a difference of delay between the audio signals received by the two microphones, such that the location of an audio source can be calculated.

### Second Embodiment

As shown in FIG. 4, the present invention further provides an intelligent home system 100 comprising at least two intelligent switches 102 as any one described above; a router 104; a mobile terminal 106 controlling the intelligent switches 102; a cloud server 108 connected with the intelligent switches 102 and the mobile terminal 106 respectively through the router 104; household appliances 110 connected with the intelligent switches 102, wherein the mobile terminal 106 controls power on and off of any of the household appliances 110 via corresponding intelligent switches 102. The mobile terminal 106 can be connected with the intelligent switches 102 directly through Wi-Fi communication for data inter-transmission and controlling.

Specifically, the intelligent switches 102 are connected with the router 104 through a Wi-Fi communication module. The intelligent switches 102 are then connected to the Internet, accessing the cloud server 108 through the Internet, and conduct Internet infrastructure services through the cloud server 108, such as calculation, storage, online backup, hosting, bandwidth, etc.

Preferably, the intelligent switches 102 further comprise sound localization units for identifying locations of a voice source according to collected sound information. The cloud server 108 further comprises a stereophonic playback unit for the cloud server, synchronizing all of the intelligent switches 102 and controlling the intelligent switches 102 to play a sound signal, e.g. from a stereo music system, through music playback modules on the intelligent switches 102. A larger networked system can be formed with a combination of multiple intelligent switches 102, so as to form a stereophonic playback system. Multiple intelligent switches 102 can simulate multitrack sound effects through coordination control by software, or switch the music to play on different intelligent switches 102 to which a person stays in close proximity according to a change of his location. Microphones on multiple intelligent switches 102 may form a microphone array through coordination control by software, in order to collect clear voice commands anywhere and judge the change of a person's location more accurately.

Preferably, the cloud server 108 further comprises an automatic switching unit for sound channels, via which the cloud server 108 controls an intelligent switch 102 in close proximity to a person to play main channel audio or to enhance sound according to the location of a voice source from the person, wherein the location of a voice source is detected by the intelligent switch 102.

Preferably, the intelligent switches 102 further comprise speech recognition units for recognizing voice commands.

The above are merely exemplary embodiments of the present invention, but are not intended to limit the present invention. It should be appreciated by one ordinary skilled in the art that, modifications and improvements may be made to the present invention without departing from the principles of the present invention, and should fall within the protection scope of the present invention.

What is claimed is:

1. An intelligent switch, comprising:
a relay;
an audio playback module;
a main control chip, wherein output terminals of the main control chip are connected with input terminals of the relay and input terminals of the audio playback module, respectively;
a wifi communication module, wherein the main control chip is connected with the wifi communication module;
an AC-DC power module, wherein output terminals of the AC-DC power module are connected with input terminals of the main control chip; and
a sound collection module, wherein output terminals of the sound collection module are connected with input terminals of the main control chip.

2. The intelligent switch according to claim 1, wherein the intelligent switch further comprises a storage device connected with the main control chip.

3. The intelligent switch according to claim 2, wherein the intelligent switch further comprises a power measurement module, wherein output terminals of the power measurement module are connected with input terminals of the main control chip.

4. The intelligent switch according to claim 3, wherein the intelligent switch further comprises a gesture-sensing module, wherein output terminals of the gesture-sensing module are connected with input terminals of the main control chip.

5. The intelligent switch according to claim 4, wherein the intelligent switch further comprises a control panel connected with the main control chip, wherein the control panel comprises a touch screen and/or buttons.

6. An intelligent home system, comprising:
at least two intelligent switches according to claim 1;
a router;
a mobile terminal controlling the intelligent switches;
a cloud server connected with the intelligent switches and the mobile terminal, respectively, through the router; and
household appliances connected with the intelligent switches, wherein the mobile terminal controls power on and off of the household appliances via the intelligent switches.

7. The intelligent home system according to claim 6, wherein the intelligent switches further comprise sound localization units for identifying locations of a voice source according to collected sound information.

8. The intelligent home system according to claim 7, wherein the cloud server further comprises a stereophonic playback unit for the cloud server operable to synchronize all of the intelligent switches and to control the intelligent switches to play stereo.

9. The intelligent home system according to claim 8, wherein the cloud server further comprises an automatic sound channel switching unit for the cloud server controlling an intelligent switch in close proximity to a person to play a main channel audio or to enhance sounds according to a detected location of a voice source.

10. The intelligent home system according to claim 1, wherein the intelligent switch further comprises a speech recognition unit for recognizing voice commands.
